(19) United States
(12) Patent Application Publication
(10) Pub. No.: US 2012/0328467 A1
(43) Pub. Date: Dec. 27, 2012

(54) METHOD FOR THE PRODUCTION OF MIXED OXIDES AND PERMANENT MAGNETIC PARTICLES

(76) Inventors: Claudio FERNANDEZ ACEVEDO, Los Arcos (Navarra) (ES); Luis Martinez De Morentin Osaba, Los Arcos (Navarra) (ES); Tamara Oroz Mateo, Los Arcos (Navarra) (ES); Cristina Salazar Castro, Los Arcos (Navarra) (ES); Angelica Perez Manso, Los Arcos (Navarra) (ES); Ana Carmen Esparza Hermoso, Los Arcos (Navarra) (ES)

(21) Appl. No.: 13/453,240

(22) Filed: Apr. 23, 2012

Related U.S. Application Data
(63) Continuation of application No. PCT/ES2011/070446, filed on Jun. 21, 2011.

(51) Int. Cl. H01F 1/01; C22C 38/00; B22F 9/20

(52) U.S. Cl. 420/83; 75/348; 75/346; 75/345

(57) ABSTRACT

Method for the production of mixed oxides and permanent magnetic particles, based on rare earths-transition metals to produce RETM magnetic materials, comprising the preparation of a parent compounds mixture; introducing the parent compound mixture into a reactor with heat energy input, where the atomization die generates fine droplets as spray or aerosol; subjecting the fine droplets formed to pyrolysis and combustion, and; reducing the mixed oxide particles formed and collected as homogenous powder, obtaining permanent magnetic particles; being a simple method and allowing to obtain homogeneous and versatile compositions, especially for Rare Earth-Transition Metal (RETM) type permanent magnets, where RE (rare earth) can be, for example, an element such as neodymium, praseodymium, dysprosium or a combination thereof, among other possibilities, and TM (transition metal) can be, for example, iron, cobalt, nickel or a combination thereof.

### OBJECT OF THE INVENTION

The following invention, as expressed in the title of this specification, relates to a method for the production of mixed oxides and permanent magnetic particles, being a simple method and allowing to obtain homogeneous and versatile compositions, especially for Rare Earth-Transition Metal (RETM) type permanent magnets, where RE (rare earth) can be, for example, an element such as neodymium, praseodymium, dysprosium or a combination thereof, among other possibilities, and TM (transition metal) can be, for example, iron, cobalt, nickel or a combination thereof, among other possibilities, while other elements such as, for example, boron, may be present or no.

This specification describes an alternative and cheaper method to obtain, in particular, RETM type permanent magnets by means of pyrolytic synthesis in a broad range of RETM homogeneous oxide proportions, appropriate for, in a second step, melting in a reducing atmosphere and producing RETM type permanent magnets.

With this method, individual RE and TM elements and other compounds normally used in the production as starting point are replaced by a single RETM type homogeneous oxide, thus avoiding the high-energy consumption of the processes currently used in the magnet manufacturing industry, while also obtaining products with greater homogeneity and therefore better performance.

In a preferred embodiment of this invention, the production could take place in a single step through the spray pyrolysis method of particles with a single NdFeB oxide with the appropriate proportions of Nd, Fe and B, obtaining an oxide composition, which by reduction results in Nd₂Fe₁₄B. With this method, the complex processes currently needed for homogenization when starting from the Nd, Fe, and B compounds separately are avoided. In this case, the oxide to be reduced already has the desired composition and a high level of homogeneity.

### TECHNICAL FIELD

This specification describes a method for the production of mixed oxides that, by reduction, allows to obtain permanent magnetic particles, which is scalable for the production, in particular, of permanent magnets with RETM compositions, which are applicable in the magnet manufacturing industry.

RETM type permanent magnets are used in a large number of products requiring potent permanent magnets, such as engines, hard drive units, generators, magnetic sensors, etc.

Likewise, magnetic particles derived from this invention can have other applications in ferrofluids, refrigeration systems, and multi-terabit information storage devices.

### BACKGROUND OF THE INVENTION

Permanent magnets are magnetic materials that keep their magnetism after being magnetized. They simultaneously present a high remnant polarization, high coercivity (higher than 10 kAm⁻¹) and important energy products (BH)ₘₐₓ.

Permanent magnets are used in particular for data storage and energy transformation (hard drive units, engines, generators, speakers, magnetic sensors, etc.). They are also used to exercise forces over non-permanent magnets or mobile armours (separators, magnetic elevators, etc.) or over charged particle guides (electron beam control devices), among other examples.

One of the main objectives of the development of permanent magnets is the manufacturing of increasingly smaller and more potent magnets, which allows the miniaturization of the devices hosting them, for example, in electronic applications. In this way, there has been produced an increase in the demand for the improvement of the materials of permanent magnets. The main materials in the manufacturing of permanent magnets include, among others, alnico-type alloys (aluminium, nickel, cobalt), permanent ferrites (strontium and barium ferrite) and rare earth magnets, the latter being the most used in applications requiring compact high-strength magnets because they possess greater energy products and coercivity.

Rare earth magnets are not used in most applications due to their cost; however, they have many features that make them superior. Dozens of magnetic materials have been developed from rare earths, however, there are two great rare earth families that are broadly used in a variety of applications, as they are SmCo and NdFeB permanent magnets.

The simultaneous discovery in Japan and in the United States (in 1983) of the excellent magnetic properties of permanent NdFeB alloys attracted the immediate attention of the scientific community because they represent a great potential in comparison with SmCo (samarium-cobalt) magnets. SmCo magnets are more expensive because they contain expensive elements, such as, samarium and cobalt, in large amounts, up to 50 to 60% by weight.

Likewise, NdFeB magnets have a greater (BH)ₘₐₓ than SmCo magnets. In fact, NdFeB magnets are the most appropriate for the manufacturing of permanent magnets, replacing SmCo magnets in most cases, because they have better properties, except for operating temperature.

Among the SmCo magnets, we can find two main compositions, the first one being the monophasic SmCo₅ and the other one being the Sm₂Co₁₇ alloy system. The magnetic properties of Sm₂Co₁₇ are generally better than the monophasic SmCo₅ ones. The former can reach a (BH)ₘₐₓ of 240 KJ/m³ against 160 KJ/m³ of the latter. The main feature of these materials is their potential to operate at high temperatures (˜500° C.), allowing for new applications, such as in the bearings of gas turbine engines.

On the other hand, the essential and predominant (but not the only) feature of permanent NdFeB magnets is the Nd₂Fe₁₄B tetragonal crystalline phase. This phase has an exceptionally high magnetocrystalline uniaxial anisotropy, giving the compound the possibility of having high coercivity. This magnetic phase has the potential to store large amounts of magnetic energy (BHₘₐₓ˜512 KJ/m³ or 64 MG·Oe) considerably more than samarium cobalt magnets (SmCo). Other possible compositions are represented by the general formula (RE-RE′)₂(Fe-TM)₁₄B, where RE is neodymium, samarium and/or praseodymium, and RE′ is one or more rare earth elements from the yttrium, lanthanum, cerium, europium, gadolinium, terbium, dysprosium, holmium, erbium, thulium, ytterbium and lutetium group. With regard to the transition metal, TM is one or more transition metal from the group made up by cobalt, nickel, manganese, chromium and copper.

In practice, the magnetic properties of rare earth-based magnets depend on the composition of the alloy, its microstructure, and the manufacturing technique used.

Since the discovery of the excellent magnetic properties of rare earth-based permanent magnet alloys, research has been focused in looking for new manufacturing techniques and an optimal microstructural development. The most commonly used processes for the production of rare earth-based magnetic alloys are based on powder metallurgy methods and rapid solidification techniques, also known as “melt spinning”.

The conventional production technology of this kind of permanent magnets includes, depending on the specific case, the following main operations: manufacturing a homogenous ingot, reducing its size until obtaining a powder, pressing in a magnetic field, sintering, thermal treatment, and magnetization.

In most cases, the development of magnetic compositions requires the preparation of a homogeneous ingot. To this end, the right proportions of the elements making up these compositions, such as rare earths, transition metals, and boron are intermixed. The mixture is melted in an oven and is rotated and remelted at least three times to achieve an alloy as homogenous as possible. On one hand, numerous fusion steps requiring an extensive use of energy to achieve a high level of homogeneity are necessary in these processes, added to the need of maintaining all steps under a controlled atmosphere to prevent the metals' tendency to oxidize.

Other alternative methods include the process called mechanical alloying, which is a high-energy grinding process with a ball mill to produce the alloy by means of a repeated welding and the fracture of the powder particles. Therefore, achieve homogenous compositions of the compounds making up the magnet implies a long time and a costly process that can be simplified by means of this invention.

In the case of power metallurgy methods to form sintered magnets after forming the ingot, the same is pulverized and the magnetic alignment and sintering in liquid phase into dense blocks takes place. Subsequently, they are subjected to thermal treatment, cut in a certain way, their surface is treated, and they are magnetized.

In “melt spinning” processes, the ingot is melted and used to produce a ribbon-shaped powder material. In this process, the melted alloy is expelled to the surface by a spinning wheel and cooled by water, achieving cooling rates in the range of one million ° C./s.

The microstructure and magnetic properties of NdFeB ribbons formed with the “melt spinning” techniques are very sensitive to cooling speed, obtaining the highest coercivities with the use of optimal speeds. Subsequently, the NdFeB bonded magnets are prepared by pulverizing the ribbons and mixing the obtained particles with polymers. This type of magnets, known as “bonded magnets”, offers less flow than sintered magnets but can be configured into a web shape and do not suffer significant losses of parasitic currents. On the other hand, it is possible to hot press nanocrystalline particles to turn them into fully dense isotropic magnets, which, following a forging and extrusion process, turn into high-energy anisotropic magnets.

Given this situation, it would be very important to develop new methods to obtain homogeneous particles for the magnet production. With the method hereby referred, we would avoid the mixing of metallic elements (in some cases from the rare earth oxide treated with a reducing agent), the remelting, and the subsequent grindings steps. Therefore, this invention develops a simplified method to obtain compositions of homogenous mixtures of oxide particles according to the required nominal composition in one single step through pyrolysis or similar methods, avoiding the grinding and remelting processes. The simple reduction of mixed oxides in this invention will achieve an easy production of rare earth-based permanent magnets, such as, for example, the Nd₂Fe₁₄B tetragonal magnetic phase, or the SmCo compositions.

### DESCRIPTION OF THE INVENTION

This specification describes a method for the production of mixed oxides and permanent magnetic particles, based on rare earths-transition metals to produce RETM type magnetic materials, whose method consists of:
the preparation of a mixture of parent compounds, with or without solvent, containing stoichiometric amounts of rare earth and transition metal with or without boron,
introducing the parent compound mixture into a reactor with heat energy input, where the atomization die generates fine droplets as a spray or aerosol,
subjecting the fine droplets formed to pyrolysis and combustion, forming mixed oxide particles, and;
reducing the mixed oxide formed and collected, in homogeneous powder form, obtaining permanent magnetic particles.

The parent compound mixture is in a liquid or vapour phase and the metallic parent compounds are based on organometallic compounds, nitrates, inorganic acids, and/or chlorides.

On the other hand, the solvents of the parent compound mixture are alcohols, organic acids, glycols, aldehydes, ketones, ethers, aromatic compounds, alkanes or fuel oils, also including inorganic solvents and their mixtures.

The introduction of the parent compound mixture into the reactor also implies the introduction of air, oxygen or other reactive and non-reactive gases to achieve the formation of the spray, refrigeration, dilution and other uses as carrier for other compounds.

In addition, the introduction of combustion gases into the reactor causes the formation of the supporting flame with oxidizing gases, such as oxygen or air.

Pyrolysis is produced in a combustion flame, a controlled temperature oven, a plasma reactor, or a laser-based reactor.

The introduction of the parent compound for pyrolysis is not limited to the formation of a spray, but also by other means of evaporation, which may take place before reaching the pyrolysis chamber or inside it.

The composition of the mixed oxide is such that after the reduction, the magnetic particles have a rare earth content of 2-70%, relating to the number of atoms, where the preferred rare earth are neodymium, samarium, and/or praseodymium, even rare earths from other elements such as lanthanum, cerium, terbium, dysprosium, holmium, erbium, europium, gadolinium, promethium, thulium, ytterbium, lutetium or yttrium and/or their mixtures could be used, provided that they do not exceed 50%, containing in addition transition metals with atomic percentages between 15-98%, so that the transition metals are preferably iron, cobalt, nickel, chromium, copper or manganese; where boron may be used in the magnet compositions, in which case its atomic percentage cannot be higher than 50%, using other additional elements with atomic percentages lower than 10%, such as zirconium, titanium, vanadium, germanium, niobium, molybdenum, aluminium, tin, tantalum, tungsten, antimony, carbon, silicon and/or hafnium.

The size of the mixed oxide particles obtained is in the range of 1-1000 nm, and the average particle size is 10-500 nm.

The generation of fine droplets in the reactor can be carried out by an ultrasonic atomizer, a nebulizer, or any other droplet-generating element.

According to the method of the invention, after the reduction, the mixed oxide results in magnetic particles with a 2-70% rare earth content, referring to the number of atoms, preferably neodymium, samarium and/or praseodymium rare earths, even including other possible rare earths, not exceeding a 50%, such as lanthanum, cerium, terbium, dysprosium, holmium, erbium, europium, gadolinium, promethium, thulium, ytterbium, lutetium or yttrium and/or their mixtures, as long as the transition metal content ranges between an atomic percentage of 15-98%; and the transition metals are preferably iron, cobalt, nickel, chromium, copper or manganese; where boron may be used, in which case its atomic percentage cannot be higher than 50%; and other additional elements with atomic percentages lower than 10% may even be used, such as zirconium, titanium, vanadium, germanium, niobium, molybdenum, aluminium, tin, tantalum, tungsten, antimony, carbon, silicon, and/or hafnium.

In addition, after the mixed oxide reduction process, the magnetic material obtained can have several uses, and thus may be used as a magnetic particle, for the production of isotropic “bonded magnets” or anisotropic magnets; as raw material for the elaboration of ingots for the production of permanent magnets or for the production of magnetic and non-magnetic rare earth-based alloys.

Likewise, after the mixed oxide reduction process, the magnetic material obtained may be used directly in industrial applications with rare earth-based compounds or as magnetic particles.

To supplement the description that is going to be made below, and with the purpose of facilitating a greater comprehension of the features of the invention, this specification is accompanied by a drawing, in whose FIGURE the most characteristic details of the invention are represented by way of illustration and not by way of limitation.

### BRIEF DESCRIPTION OF THE FIGURE

FIG. 1. Shows a diagram with the steps of the method for the production of mixed oxides for their use as magnetic particles by reduction; the diagram corresponds to the specific case of the Nd₂Fe₁₄B tetragonal phase, although it may extend to other cases.

### DESCRIPTION OF A PREFERRED EMBODIMENT

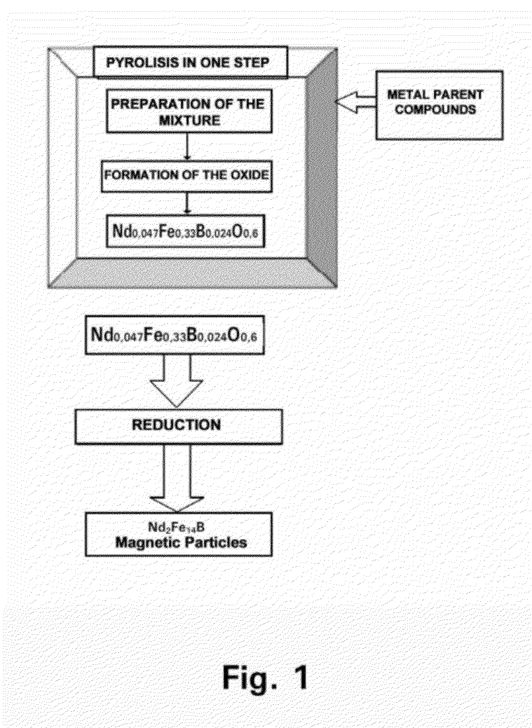

Taking into account the aforementioned FIGURE and according to the adopted numbering, we can observe how the diagram of FIG. 1 shows the different steps involved in the method for the production of mixed oxides for permanent magnets, providing an appropriate method for the production of permanent magnets based on the rare earth-transition metal system, improving their homogenization, densified structure and final performance.

Thus, the invention consists of the production in one single step of mixed metallic oxides, such as Nd_{0.047}Fe_{0.33}B_{0.024}O_{0.6}, by means of a method, preferably spray flame pyrolysis, from metal parent compounds, preferably liquid compounds, especially liquid organometallic parent compounds, to obtain powder particles with the desired stoichiometric composition. In the indicated example, the Nd_{0.047}Fe_{0.33}B_{0.024}O_{0.6} metallic mixed oxide particles can be reduced in a second step for the formation of the Nd₂Fe₁₄B magnetic phase.

### I. RE-TM-Based Oxide Synthesis by Pyrolysis

According to the method of the invention, an embodiment consists on introducing a liquid metal parent compound, whether mixed with a solvent or not, into a flame reactor. Other methods may use other means of energy input other than the flame, such as plasma, controlled temperature ovens, or laser, among others.

On the other hand, in the flame pyrolysis process used as an example, the liquid medium is heated and the evaporation and combustion of the solvents and the parent compound mixture, as well as the formation of mixed oxide nanoparticles is produced inside the flame, whereby obtaining particles with the desired composition and characteristics.

### A. Preparation of the Liquid Mixture

In a typical experiment for a preferred mixed oxide composition of Nd_{0.047}Fe_{0.33}B_{0.024}O_{0.6}, stoichiometric amounts of liquid parent compounds containing the aforementioned metals (neodymium, iron and boron) are dissolved in the appropriate solvents.

Metalorganic parent compounds comprising the metal in question, are preferred, but alternatively, other parent compounds could include nitrates, inorganic acids, chlorides and others, whether in a liquid medium or not, containing metal concentrations of neodymium, iron and boron or the required corresponding element.

Alcohols such as methanol, ethanol, isopropanol, butanol, among others, organic acids, glycols, aldehydes, ketones, ethers, aromatic compounds such as toluene or xylene, alkanes such as, for example, hexane and isooctane, or fuel oils, such as mineral oils or kerosene are included to dissolve the parent compounds. Aside from organic solvents, inorganic liquids may be used as solvents, such as water-based solutions and organic-inorganic solvent mixtures.

On the other hand, the properties of the parent compound-solvent liquid mixture may vary depending on how the liquid mixture affects the operating characteristics, for example, the mixture's fluidity, combustibility, temperature or the impurities present in the produced particles. The amounts of solvent sand parent compounds in the mixture may vary widely depending on the parent compound's metal content and also on the desired composition of the particles formed in the pyrolysis process.

### B. Pyrolysis for the Production of Mixed Oxide

The parent compound and solvent mixture is introduced into a pyrolysis reactor, preferably into a flame reactor, where the liquid medium is atomized to form fine droplets as a spray or aerosol by means of atomization dies, nebulizers, ultrasonic atomizers, or other elements capable of producing fine droplets.

Other methods include the introduction of the use of bubblers, sublimation systems or others with the purpose of providing the initial mixture as a vapour.

In the method of the invention dies with dispersing gas input, which may be reactive or inert gas, are preferred, in this case an oxidizing gas such as O₂ or air is chosen, and the droplets are generated by the dispersing gas affecting the liquid parent compound, and they are introduced in the gas phase in a supporting flame. The gas phase may include a gas fuel such as methane, which could also be propane, butane, etc., and also includes an oxidizer such as O₂ or air with the purpose of maintaining the flame.

In other cases, non-reactive gases such as inert N₂ or others could also be present for the cooling, dilution or as carriers for other compounds.

Once the droplets are generated, they are heated on the flame, where the liquid, in the case of liquid parent compounds, evaporates and the fuel present in the droplets is burned in the oxidizing flame. Thus, the rare earths, the transition metals, and the other existing required elements in the parent compounds, and in the preferred embodiment, neodymium, iron and boron are oxidized forming homogenous particles of the combined mixed oxide. The formation mechanism of the particles includes the evaporation of droplets, combustion, nucleation, coagulation, sintering and even superficial growth occurring at the same time. Preferably, in the example, the particles produced in the flame have the preferred composition of Nd_{0.047}Fe_{0.33}B_{0.024}O_{0.6}.

The distribution of the particle sizes obtained has a range between 1 nm to 1000 nm, with an average particle size in the range of 10 nm-500 nm. Continuing with the example, one of the advantages of the present invention is that the Nd—Fe—B mixed oxide particles can be produced at a high rate from grams per hour to tons per hour.

Adequate pyrolysis processes are those comprising the introduction of the parent compounds into a reactor with heat input, where the droplets, unless previously supplied as vapour, are first evaporated and then the corresponding chemical reactions to form the particles of the desired product follow one another takes place. Although the preferred method herein is spray flame combustion, other appropriate methods may include controlled temperature ovens, plasmas, or laser, among others.

### C. Recollection and Manipulation of Nanoparticles

Mixed oxide nanoparticles are collected to separate solid material particles from gases. In the method of the invention, used devices are adapted for solid-gas separation processes. Preferably, as a method bag filters are used, other appropriate methods are electrostatic precipitators, cyclones, or collection devices using liquids, such as scrubbers or others. The nanoparticle powder may be treated with gases, liquids, or thermal treatments with the purpose of purifying, adding, or modifying its properties.

After collecting the nanoparticles, the mixed oxide with the desired composition produced in one single step, which in the example would be Nd_{0.047}Fe_{0.33}B_{0.024}O_{0.6}, is reduced in a second step with the purpose of obtaining the Nd₂Fe₁₄B magnetic metallic phase, as is the case in this example. The use of reducing agents in solid-state reactions, the application of thermal processes, electrolytic processes, among others, are included as appropriate processes for the reduction. Here, the advantage is that the nominal composition of the desired magnet will be reduced in an additional step starting from the mixed oxide produced with the desired composition and a high level of homogeneity, avoiding the separate reduction steps for each compound, the mixing and remelting processes and the grinding processes, all of which must be carried out under an inert atmosphere.

The method of the invention includes composition including mixed oxides with a range of compositions of the different compounds, RE and TM, with or without boron and with the corresponding stoichiometric oxygen for the total oxidation of the compounds, so the composition of the magnet will have the general formula TR_{X}MT_{Y}B. In most cases, “X” is the total rare earth content, which is in the range between X=0.02 to 0.7 and “Y” corresponds to the total transition metal content and is found in a composition, such that Y=0.15 to 0.98, and, where “Z” is the amount of boron in the composition, such that Z=0.0 to 0.5, being X+Y+Z=1.

The most adequate elements to be included as rare earths are, preferably, neodymium, praseodymium, and/or samarium, other additional rare earth elements may be included, for other purposes, in amounts of up to 50% atomic. Rare earths such as lanthanum, cerium, terbium, dysprosium, holmium, erbium, europium, gadolinium, promethium, thulium, ytterbium, lutetium or yttrium and/or their mixtures are among the possible additional rare earths.

The transition metals included are, preferably, iron, cobalt, nickel, chromium, copper or manganese. The TM used in the composition will participate with an atomic percentage ranging between 15 and 98%. Boron may be used or not in the magnet's composition, so that if boron is used, it cannot be in an atomic percentage higher than 50%. Other additional elements to be included in atomic percentages lower than 10% are zirconium, titanium, vanadium, germanium, niobium, molybdenum, aluminium, tin, tantalum, tungsten, antimony, carbon, silicon and/or hafnium.

The method object of the invention includes the production of mixed oxide particles that, after a reduction process, allows obtaining permanent magnetic nanoparticles useful for the production of isotropic bonded magnets, the production of anisotropic magnets by means of pressure and alignment, the production of raw materials with the purpose of producing magnets by means of “melt spinning” processes, the production of raw materials to obtain primary ingots with which to manufacture permanent magnets and the production of magnetic and non-magnetic rare earth-based alloys.

Likewise, we can indicate that with the purpose of making the most of the advantages of the good magnetic properties of rare earth-based permanent magnets, it is necessary to achieve homogenous compositions of the metal alloys forming the magnetic phases, such as, for example, the Nd₂Fe₁₄B tetragonal phase, the SmCo₅ monophase, or the Sm₂Co₁₇ alloy system, and generate these magnetic particles allowing an easier handling and processing of magnets.

For the development of more homogenous magnetic compositions in the production processes of permanent magnets at an industrial scale while simplifying the procedure, decreasing the production costs, the pyrolysis method based on the introduction of metallic parent compounds subject of this invention, was developed.

In terms of the developed pyrolysis method, the innovation consists in that the mixed oxide homogeneous compositions necessary to obtain RETM type permanent magnets are obtained in one single step and the subsequent reduction of the homogeneous compound results in an homogenous composition of RETM type magnets, achieving a higher level of uniformity in the alloy than the one obtained in the alloying of individual raw materials, and avoiding the large expenditure of energy and the complex mixing, alloying and grinding steps to obtain the powders.

In the present invention, the synthesis through pyrolysis allows keeping the stoichiometric composition of the particles over the parent compound mixture, ensuring a high level of homogeneity both in the magnet's composition and in its structure, also allowing the introduction of other elements and other compositions based on rare earth-transition metal magnets.

Another advantage of the pyrolysis process is that the mixed oxide compositions for the manufacturing of magnets can be obtained at an industrial level, ensuring the scalability of the process from grams per hour to tons per hour.

Another additional advantage of this process is that, given that the produced particles have smaller sizes, ranging from nanometers to some micrometers, their pressing to form the magnet will allow a denser body given that the smaller particles have higher superficial energies and their interaction is improved, filling the interstices better. The sintering of denser bodies results in more compact magnetic materials, thereby improving magnetic properties per volume unit.

Another great advantage is that the reduction reaction, with the purpose of obtaining the RETM metal alloy, is avoided until the final steps of magnet production, suppressing the complex handling under inert atmospheres as happens in the conventional steps. Likewise, since the particles are already produced as powder, the high-energy consuming mechanical grinding is thus avoided, which ultimately produces a degradation of their crystalline structure, therefore affecting the magnetic properties of the permanent magnetic materials.

Therefore, the novelty of the invention when compared with the typical physical metallurgy methods, such as powder metallurgy, “melt spinning”, or others, is that the method described in the present patent provides controlled and homogenous compositions in the oxide mixtures for the production of magnets in one single step, which by means of reduction processes would translate into RETM magnetic phases, such as TR₂MT₁₄B, TRMT₅ or TR₂MT₁₇ alloys.

This process eliminates the need of multiple steps requiring high energy consumption, such as the successive mixing and fusion of the rare earth metal with the transition metal, for example, mixing and melting iron, boron and/or ferroboron with neodymium or neodymium oxide in a reducing atmosphere, melting and molding the ingot several times and grinding it into fine particles. These processes are fully replaced by the present invention, achieving mixed oxide particles for magnetic purposes at a large scale and in fewer steps, thus decreasing costs and facilitating the compounds handling.

The following examples illustrate the practicality of the invention.

### Example 1

A mixed oxide with a nominal composition of Nd_{0.047}Fe_{0.33}B_{0.024}O_{0.6} was produced by spray flame pyrolysis. A liquid parent compound mixture was prepared with 59.3 g of neodymium acetylacetonate (C₁₅H₂₁NdO₆), 875.8 g of iron 2-ethyl-hexanoate in mineral oils (Fe 6%) and 15.6 g of tri-n-butyl borate ([CH₃(CH₂)₃O]₃B) dissolved in xylene. Xylene is added to obtain a total metal concentration of 0.8 M.

The liquid mixture was fed with a pump at 48 ml/min through a die with an output size of 0.8 mm and with a 100 L/min dispersion gas flow of O₂. The supporting flame is formed with the use of an O₂ 8 L/min flow and a CH₄ 4 L/min flow.

For the collection of mixed oxide particles with a final composition of Nd_{0.047}Fe_{0.33}B_{0.024}O_{0.6}, bag filters were used as a separation system.

Finally, the mixed oxide particles were subjected to a reduction process to obtain permanent magnetic nanoparticles.

### Example 2

A mixed oxide with a nominal composition of Sm_{0.04}Co_{0.36}O_{0.6} was produced by spray flame pyrolysis. A mixture of liquid parent compounds was prepared with 50 g of samarium acetylacetonate and 523 g of cobalt 2-ethyl hexanoate (65% by weight in mineral oils) dissolved in xylene. The mixture's total metal concentration was adjusted at 0.5 M. The liquid mixture was fed with a pump at 50 mL/min through a die with a 0.8 mm aperture and a 100 L/min dispersion gas flow of O₂. The supporting flame is formed with the use of an O₂ 8 L/min flow and a CH₄ 4 L/min flow. Bag filters were used to collect the mixed oxide particles with a final composition of Sm_{0.04}Co_{0.36}O_{0.6}.

Finally, the mixed oxide particles were subjected to a reduction process to obtain permanent magnetic nanoparticles.

1. Method for the production of mixed oxides and permanent magnetic particles, based on rare earths-transition metals to produce RETM type magnetic materials, whose method comprises:
the preparation of a mixture of parent compounds, with or without solvent, containing stoichiometric amounts of rare earth and transition metal with or without boron,
introducing the parent compound mixture into a reactor with heat energy input, where the atomization die generates fine droplets as a spray or aerosol,
subjecting the fine droplets formed to pyrolysis and combustion, forming mixed oxide particles, and;
reducing the mixed oxide particles formed and collected, in an homogeneous powder form, obtaining permanent magnetic particles.

2. Method for the production of mixed oxides and permanent magnetic particles according to claim 1, wherein the parent compound mixture is in a liquid or vapour phase and the metallic parent compounds are based on organometallic compounds, nitrates, inorganic acids and/or chlorides.

3. Method for the production of mixed oxides and permanent magnetic particles according to claim 1, wherein the solvents of the parent compound mixture are alcohols, organic acids, glycols, aldehydes, ketones, ethers, aromatic compounds, alkanes or fuel oils, also including inorganic solvents and their mixtures.

4. Method for the production of mixed oxides and permanent magnetic particles according to claim 1, wherein the introduction of the parent compound mixture into the reactor also implies the introduction of air, oxygen or other reactive and non-reactive gases to achieve the formation of the spray, refrigeration, dilution and other uses as a carrier for other compounds.

5. Method for the production of mixed oxides and permanent magnetic particles according to claim 1, wherein the introduction of combustion gases into the reactor causes the formation of the supporting flame with oxidizing gases such as oxygen or air.

6. Method for the production of mixed oxides and permanent magnetic particles according to claim 1, wherein pyrolysis is produced in a combustion flame, a controlled temperature oven, a plasma reactor or a laser-based reactor.

7. Method for the production of mixed oxides and permanent magnetic particles according to claim 1, wherein the introduction of the parent compound for pyrolysis is not limited to the formation of a spray, but also by other means of evaporation, which may take place before reaching the pyrolysis chamber or inside it.

8. Method for the production of mixed oxides and permanent magnetic particles according to claim 1, wherein the composition of the mixed oxide is such that after the reduction, the magnetic particles have a rare earth content of 2-70%, relating to the number of atoms, where the preferred rare earth are neodymium, samarium and/or praseodymium, even rare earths from other elements such as lanthanum, cerium, terbium, dysprosium, holmium, erbium, europium, gadolinium, promethium, thulium, ytterbium, lutetium or yttrium and/or their mixtures could be used, provided that they do not exceed 50%, containing in addition transition metals with atomic percentages between 15-98%, so that the transition metals are preferably iron, cobalt, nickel, chromium, copper or manganese; where boron may be used in the magnet compositions, in which case its atomic percentage cannot be higher than 50%, using other additional elements with atomic percentages lower than 10%, such as zirconium, titanium, vanadium, germanium, niobium, molybdenum, aluminium, tin, tantalum, tungsten, antimony, carbon, silicon and/or hafnium.

9. Method for the production of mixed oxides and permanent magnetic particles according to claim 1, wherein the size of the mixed oxide particles obtained is in the range of 1-1000 nm, and the average particle size is 10-500 nm.

10. Method for the production of mixed oxides and permanent magnetic particles according to claim 1, wherein the generation of fine droplets in the reactor can be carried out by an ultrasonic atomizer, a nebulizer or any other droplet-generating element.

11. Method for the production of mixed oxides and permanent magnetic particles according to claim 1, wherein after the reduction, the mixed oxide results in magnetic particles with a 2-70% rare earth content, referring to the number of atoms, preferably neodymium, samarium and/or praseodymium, even including, not exceeding a 50%, other possible rare earths elements such as lanthanum, cerium, terbium, dysprosium, holmium, erbium, europium, gadolinium, promethium, thulium, ytterbium, lutetium or yttrium and/or their mixtures, also containing transition metals with atomic percentages between 15-98%, so that transition metals are preferably iron, cobalt, nickel, chromium, copper or manganese; where boron may be used, in which case its atomic percentage cannot be higher than 50%; and other additional elements with atomic percentages lower than 10% may even be used, such as zirconium, titanium, vanadium, germanium, niobium, molybdenum, aluminium, tin, tantalum, tungsten, antimony, carbon, silicon and/or hafnium.

12. Use of the permanent magnetic particles obtained after the reduction process of the mixed oxide according to the method of claim 1 as raw material for the elaboration of ingots for the production of permanent magnets.

13. Use of the permanent magnetic particles obtained after the reduction process of the mixed oxide according to the method of claim 1 as a permanent magnetic particle for the production of isotropic “bonded magnets” or anisotropic magnets.

14. Use of the permanent magnetic particles obtained after the reduction process of the mixed oxide according to the method of claim 1 for the production of magnetic and non-magnetic rare earth-based alloys.

15. Use of the permanent magnetic particles obtained after the reduction process of the mixed oxide according to the method of claim 1 in industrial applications with rare earth-based compounds.
